(19) United States
(12) Patent Application Publication
(10) Pub. No.: US 2007/0114928 A1
(43) Pub. Date: May 24, 2007

(54) PLANAR LIGHT SOURCE AND METHOD FOR FABRICATING THE SAME

(76) Inventors: Chao-Jen Chang, Taoyuan County (TW); Su-Chiu Lee, Taipei County (TW); Hsiang-Hui Teng, Taoyuan County (TW); Yu-Heng Hsieh, Taipei City (TW); Hon-We Wu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,543

(22) Filed: Nov. 29, 2005

(30) Foreign Application Priority Data
Nov. 23, 2005 (TW) 94141090

(51) Int. Cl. H01J 17/49

(52) U.S. Cl. 313/582

(57) ABSTRACT

A planar light source having a first substrate, a plurality of electrode modules, a second substrate, a dielectric spacer, a first phosphor layer, and a discharge gas is provided. The electrode modules are disposed on the first substrate. The second substrate is disposed above the first substrate. The dielectric spacer covers the electrode modules and is connected between the first substrate and the second substrate. The space between the first substrate and the second substrate is divided into a plurality of discharge spaces by the dielectric spacer. The first phosphor layer is disposed in the discharge spaces. The discharge gas is disposed in the discharge spaces. The coating area of the phosphor layer can be increased and cracks in the substrate can be prevented due to the simple structure of the planar light source.

### BACKGROUND OF THE INVENTION

1. Field of Invention

The present invention relates to a planar light source and the fabricating method thereof. More particularly, the present invention relates to a planar light source with a simple structure and the fabricating method thereof with simplified process.

2. Description of Related Art

The planar light source is widely used in the backlight of LCD display panels and even other fields because it has excellent light-emitting efficiency and evenness, and is capable of providing the light source for a large area. The planar light source is a kind of plasma light-emitting device, wherein, electrons emitted from the cathode will move between the cathode and the anode and collide with the inert gas in the discharge space so that the gas will be ionized and excited to form plasma. After that, the excited atoms in the plasma will degenerate into ground state with emitting Ultra-Violet, and the emitted ultra violet will further excite the phosphor in the planar light source to produce the visible light.

FIG. 1 is a diagram of a conventional planar light source. FIG. 1 A is a partial cross-sectional view of the planar light source in FIG. 1. Referring to both FIGS. 1 and 1A, the conventional planar light source 100 includes an upper substrate 110, a lower substrate 120, a phosphor layer 130a, another phosphor layer 130b, a reflective layer 140, a dielectric layer 150, electrode modules 160, a plurality of spacers 170, and a discharge gas (not shown) located in the discharge spaces 180. Wherein, the electrode modules 160 include anodes 160a and cathodes 160b. When the electrons (not shown) emitted from the cathodes 160b move towards the anodes 160a, the electrons will collide with the discharge gas in the discharge spaces 180 to turn the discharge gas into plasma. Next, the phosphor layers 130a and 130b will be excited by the ultra violet emitted from the plasma to give off visible light.

Referring to FIGS. 1 and 1A again, to maintain the discharge spaces 180, a plurality of spacers 170 are disposed to support the upper substrate 110 and the lower substrate 120. However, the disposition of the spacers 170 will occupy some space between the upper substrate 110 and the lower substrate 120, therefore the discharge spaces 180 will be reduced accordingly. As a result, the coating area of the phosphor layers 130a and 130b located in the discharge spaces 180 will also be reduced. Moreover, frit glue will be used when the spacers 170 are disposed to paste the spacers 170 on the lower substrate 120.

FIG. 1B is a partial enlarged view of area A in FIG. 1A. Referring to FIG. 1B, the frit glue 190 is used for pasting the spacers 170 on the lower substrate 120. However, the frit glue 190 will react with the reflective layer 140 and the lower substrate 120 so that the part of the reflective layer 140 and the lower substrate 120 in contact with the frit glue 190 will be eroded. Accordingly, a crack 195 will occur in the part of the reflective layer 140 and the lower substrate 120. This will not only affect the fastening effect of the spacers 170 to the lower substrate 120, but also damage the reflective layer 140 and the lower substrate 120. Certainly, the same problem will happen to the upper substrate 110 connected to the spacers 170.

Moreover, the fabricating process of the conventional planar light source is very complicated. FIG. 2 is the fabricating flowchart of a lower substrate of the planar light source in FIG. 1. Referring to both FIGS. 1 and 2, first, the lower substrate 120 is provide, as shown in step 210. Then, the reflective layer 140 is fabricated on the lower substrate 120, as shown in step 220. Next, a plurality of electrode modules 160 are fabricated on the reflective layer 140, as shown in step 230. After that, the dielectric layer 150 is formed to cover the electrode modules 160, as shown in step 240. Next, the phosphor layer 130b is formed on the dielectric layer 150, as shown in step 250.

Note that in step 240, the required pattern and thickness of the dielectric layer 140 located on the lower substrate 120 are acquired through multiple printing processes. Since the printing process is time-consuming, the production capacity of the lower substrate 120 is decreased. Moreover, the printing process may result in uneven thickness of the pattern film due to printing shift; accordingly the light-emitting performance of different areas may be very different.

In particular, the step of disposing the spacers 170 must be performed to maintain the discharge spaces 180 when the upper substrate 110 and the lower substrate 120 are bound together. Since a plurality of spacers 170 are pasted respectively on the lower substrate 120 by the frit glue 190, the process of disposing the spacers 170 will be time-consuming and complicated, thus the production capacity of the planar light source 100 cannot be improved.

### SUMMARY OF THE INVENTION

Accordingly, the present invention is directed to provide a planar light source which can increase the coating area of the phosphor layer and prevent cracks in the substrate.

According to another aspect of the present invention, a fabricating method for a planar light source is provided, which has simple process and can increase the yield of the planar light source.

To accomplish the aforementioned and other objectives, the present invention provides a planar light source including a first substrate, a plurality of electrode modules, a second substrate, a plurality of dielectric spacers, a first phosphor layer, and a discharge gas. The electrode modules are disposed on the first substrate. The second substrate is disposed above the first substrate. The dielectric spacers cover the electrode modules and are connected between the first substrate and the second substrate, and the dielectric spacers divide the space between the first substrate and the second substrate into a plurality of discharge spaces. The first phosphor layer is disposed in the discharge spaces. The discharge gas is disposed in the discharge spaces.

In an embodiment of the present invention, the width of the part of each of the dielectric spacers in contact with the first substrate is greater than the width of the part in contact with the second substrate, and the cross section of each dielectric spacer is, for example, a trapezoid.

In an embodiment of the present invention, the thicknesses of the dielectric spacers are between about 100 μm and 5,000 μm.

In an embodiment of the present invention, the planar light source further includes a second phosphor layer covering the surface of the second substrate.

In an embodiment of the present invention, each of the dielectric spacers includes a top section and a body section, and the planar light source further includes a third phosphor layer disposed on the second substrate, and located between the top sections and in the discharge spaces.

In an embodiment of the present invention, the planar light source further includes a reflective layer disposed between the first substrate and the electrode modules.

In an embodiment of the present invention, the material of the electrode modules is selected from the group including silver, copper, and combinations thereof.

In an embodiment of the present invention, the discharge gas is selected from the group including xenon gas, neon gas, argon gas, and combinations thereof.

To accomplish the aforementioned and other objectives, the present invention further provides a fabricating method for the planar light source. First, the first substrate is provided whereon a plurality of electrode modules have been formed. Then, the dielectric material layer covering the electrode modules and having a thickness is formed on the first substrate. Next, the dielectric material layer is patterned to form a plurality of dielectric spacers. Next, the second substrate is provided and the space between the first substrate and the second substrate is divided into a plurality of discharge spaces by the dielectric spacers. After that, the first phosphor layer is formed in the discharge spaces. Then, the first substrate and the second substrate are bound together, and meanwhile, the discharge spaces are filled with the discharge gas, wherein the dielectric spacers are connected between the first substrate and the second substrate.

In an embodiment of the present invention, the method of forming the dielectric material layer on the first substrate includes a coating process.

In an embodiment of the present invention, a sinter process is further performed to the dielectric material layer after the dielectric material layer has been formed on the first substrate.

In an embodiment of the present invention, the thickness of the dielectric material layer is between about 100 μm and 5,000 μm.

In an embodiment of the present invention, the method of patterning the dielectric material layer includes the following steps: first, a photoresist film is adhered to the dielectric material layer; after that, a lithography process is performed to the photoresist film to form a patterned photoresist film; next, an etching process is performed to the dielectric material layer by using the patterned photoresist film as the etching mask to form dielectric spacers.

In an embodiment of the present invention, the method of forming the first phosphor layer in the discharge spaces includes a coating process.

In an embodiment of the present invention, the fabricating method for the planar light source further includes forming the second phosphor layer on the surface of the second substrate.

In an embodiment of the present invention, the fabricating method for the planar light source further includes forming a reflective layer on the first substrate before the electrode modules are formed.

Since in the present invention, dielectric spacers are used to replace the conventional spacers, the space occupied by the conventional spacers can be reduced and the discharge space of the planar light source in the present invention can be increased. Accordingly, the coating area of the phosphor layer in the discharge spaces can be increased. Moreover, the dielectric spacers are formed through a photolithography process. Because of without using frit glue, cracks can be prevented in the substrate. Furthermore, because the dielectric spacers are formed in a film deposition process combined with a photolithography process, the fabricating process of the planar light source in the present invention is simpler compared to the conventional process of fabricating the dielectric layer by multiple printing processes. Accordingly, the yield of planar light source can be increased.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional planar light source.

FIG. 1A is a partial cross-sectional view of the planar light source in FIG. 1.

FIG. 1B is a partial enlarged view of area A in FIG. 1A.

FIG. 2 is a fabricating flowchart of a lower substrate of the planar light source in FIG. 1.

FIG. 3 is a diagram of a planar light source according to an embodiment of the present invention.

FIG. 4 is a diagram of another planar light source according to an embodiment of the present invention.

FIGS. 5A to 5G are cross-sectional diagrams illustrating a fabricating method for a planar light source according to an embodiment of the present invention.

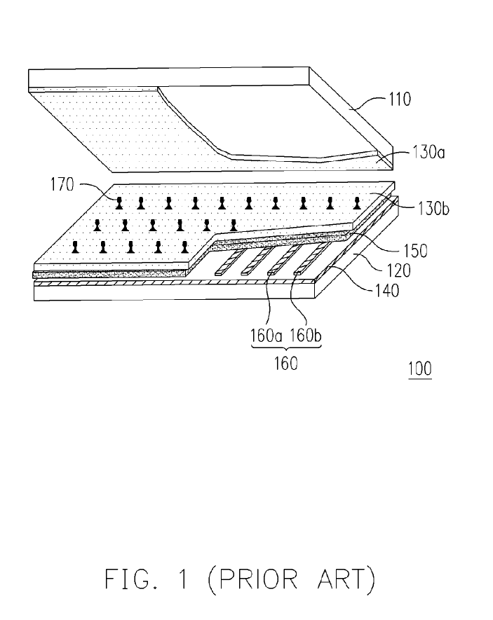

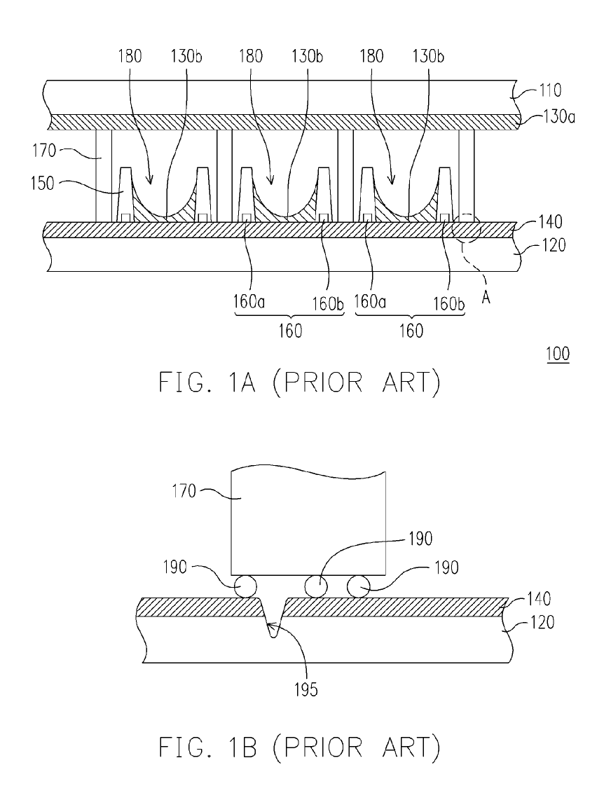

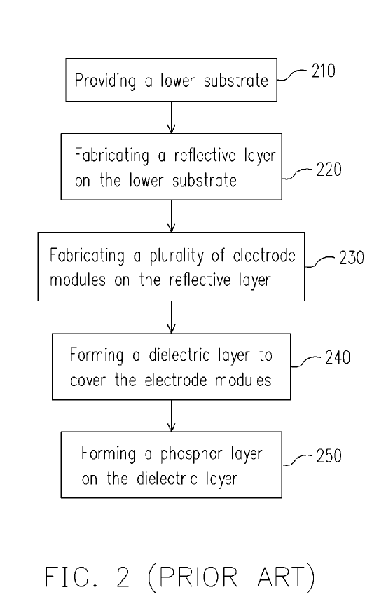

### DESCRIPTION OF EMBODIMENTS

FIG. 3 is a diagram of a planar light source according to an embodiment of the present invention. Referring to FIG. 3, the planar light source 300 includes a first substrate 310, a plurality of electrode modules 320, a second substrate 330, a plurality of dielectric spacers 340, a phosphor layer 350, and a discharge gas 360. The electrode modules 320 are disposed on the first substrate 310. The second substrate 330 is disposed above the first substrate 310. The dielectric spacers 340 cover the electrode modules 320 and are connected between the first substrate 310 and the second substrate 330, and the space between the first substrate 310 and the second substrate 330 is divided into a plurality of discharge spaces 370 by the dielectric spacers 340. The phosphor layer 350 is disposed in the discharge spaces 370. The discharge gas 360 is disposed in the discharge spaces 370.

Referring to FIG. 3 again, in an embodiment, the first substrate 310 is, for example, a glass substrate. The electrode modules 320 include anodes 320a and cathodes 320b, wherein the electrode modules 320 are arranged on the first substrate 310 in the sequence of anode 320a, cathode 320b, anode 320a, and cathode 320b. However, the electrode modules 320 may also be arranged on the first substrate 310 in the sequence of anode 320a, cathode 320b, cathode 320b, and anode 320a (not shown). In addition, the material of the electrode modules 320 is selected from the group including silver, copper, and combinations thereof.

The second substrate 330 is, for example, a glass substrate. The planar light source 300 further includes another phosphor layer 390 covering the surface of the second substrate 330. Thus, the ultra violet emitted by the plasma in the discharge spaces 370 can further excite another phosphor layer 390 to give off the visible light in addition to exciting the phosphor layer 350 to give off the visible light, so that the brightness of the planar light source 300 is increased. In an embodiment, the planar light source 300 may also have a reflective layer 380 disposed between the first substrate 310 and the electrode modules 320. The reflective layer 380 is fabricated with a material of high reflectivity and is used for reflecting visible light to further improve the efficiency of visible light utilization. The discharge gas 360 is inert gas filling up the discharge spaces 370. In an embodiment, the discharge gas 360 is selected from the group including xenon gas, neon gas, argon gas, and combinations thereof.

Note that in the present invention, the dielectric spacers 340 are disposed to replace the conventional spacers 170. In an embodiment, the width WI of the part of each dielectric spacer 340 in contact with the first substrate 310 is greater than the width W2 of the part in contact with the second substrate 330, and the cross section of each dielectric spacer 340 is, for example, a trapezoid, as shown in FIG. 3. Accordingly, the dielectric spacers are more supportive and so can better maintain the discharge spaces 370 between the first substrate 310 and the second substrate 330. Moreover, the thicknesses of the dielectric spacers 340 are between, for example, about 100 μm and 5,000 μm. In other words, the thicknesses of the dielectric spacers 340 correspond to the thicknesses of the conventional spacers 170. Therefore, the conventional spacers 170 are omitted in the present invention, and the discharge spaces 370 between the first substrate 310 and the second substrate 330 are maintained by the dielectric spacers 340.

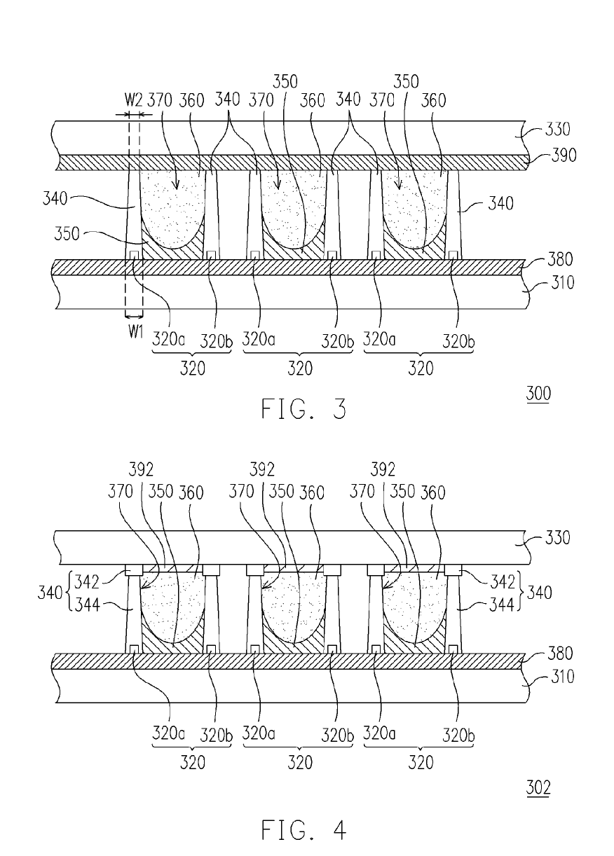

FIG. 4 is a diagram of another planar light source according to an embodiment of the present invention. Referring to FIG. 4, the composition of the planar light source 302 is similar to the composition of the planar light source 300 shown in FIG. 3, wherein same reference numerals refer to the same elements. Note that in the present embodiment, each dielectric spacer 340 includes a top section 342 and a body section 344, and the planar light source 302 further includes a phosphor layer 392 disposed on the second substrate 330 and located between the top sections 342 and in the discharge spaces 370. To be specific, in the planar light source 302, the top sections 342 of the dielectric spacers 340 are disposed on the second substrate 330 and the body sections 344 of the dielectric spacers 340 are disposed on the first substrate 310. Thus, the dielectric spacers 340 as shown in FIG. 4 can support the first substrate 310 and the second substrate 330 better to maintain the discharge spaces 370. In particular, the first substrate 310 and the second substrate 330 can be aligned effectively through the top sections 342 and the body sections 344, so that the binding precision is improved. Moreover, the disposition of the phosphor layer 392 shown in FIG. 4 may reduce the usage of the phosphor layer 392 and may further reduce the fabricating cost of the planar light source 302.

In overview, the dielectric spacers 340 in the present invention act as the conventional spacers 170. Since the conventional spacers 170 are not needed in the present invention, the discharge spaces 370 of the planar light source 300 and 302 in the present invention are larger compared to that of the conventional planar light source 100. Accordingly, the coating area of the phosphor layer 350 is increased and further the brightness of the planar light sources 300 and 302 is increased too. Moreover, since the conventional spacers 170 are not needed in the present invention, and the dielectric spacers 340 are fabricated through a film deposition process and a photolithography process, frit glue is not needed. Accordingly, cracks can be prevented in the substrate. The fabricating method for a planar light source in the present invention will be described below.

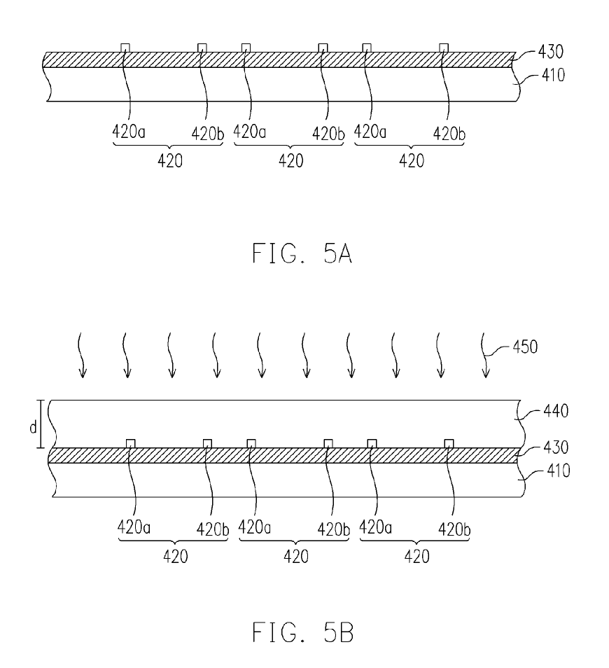

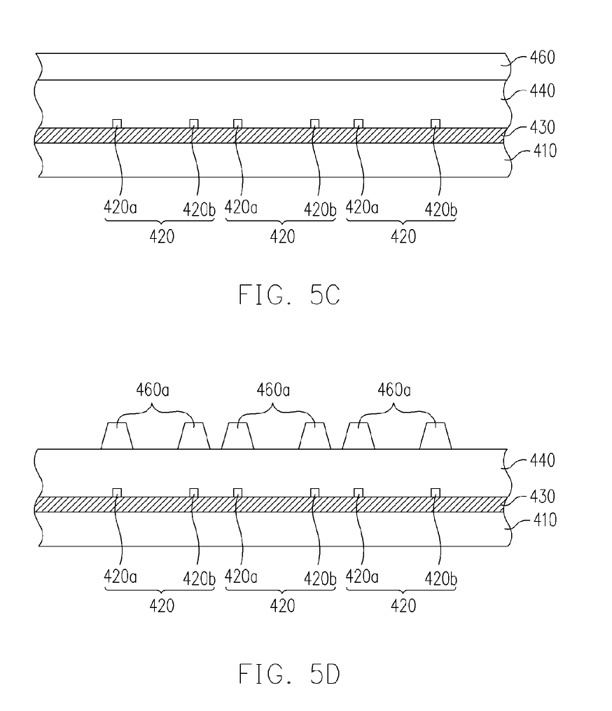

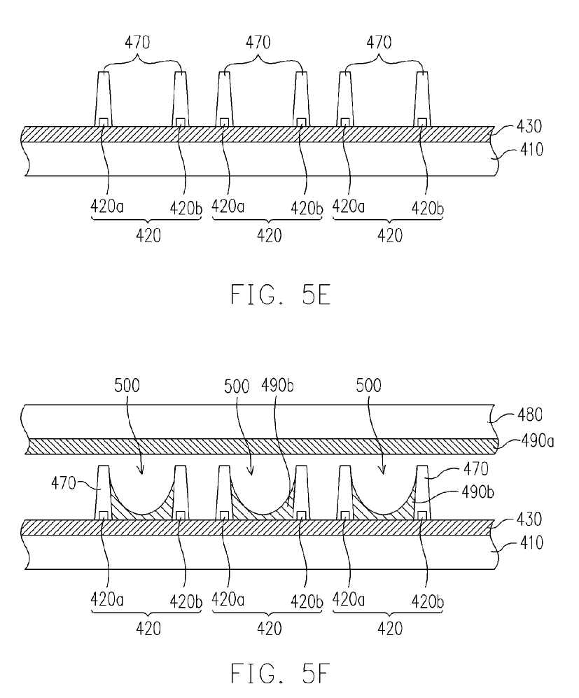

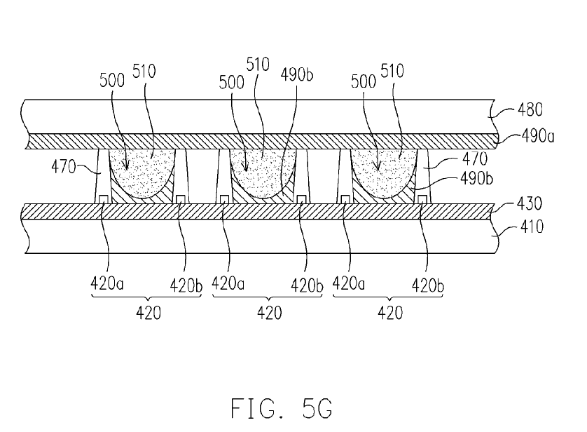

FIGS. 5A to 5G are cross-sectional diagrams of a fabricating method for a planar light source according to an embodiment of the present invention. First, a first substrate 410 is provided whereon a plurality of electrode modules 420 have been formed, as shown in FIG. 5A. In an embodiment, the electrode modules 420 have, for example, anodes 420a and cathodes 420b, and the formation method of the electrode modules 420 is, for example, a printing process, or by forming an electrode material layer (not shown) on the surface of the first substrate 410, then forming the electrode modules 420 through a photolithography process. This method is known to those skilled in the art so will not be explained again. In addition, in an embodiment, a reflective layer 430 may be formed on the first substrate 410 before the electrode modules 420 are formed. The formation method of the reflective layer 430 is, for example, a printing or coating process.

Next, a dielectric material layer 440 covering the electrode modules 420 and having a thickness d is formed on the first substrate 410, as shown in FIG. 5B. In an embodiment, the method of forming the dielectric material layer 440 on the first substrate 410 includes a coating process, and the thickness of the formed dielectric material layer 440 is between about 100 μm and 5,000 μm. In addition, a sinter process 450 is further performed to the dielectric material layer 440 to solidify the dielectric material layer 440 after the dielectric material layer 440 has been formed on the first substrate 410.

Again, the dielectric material layer 440 is patterned to form a plurality of dielectric spacers 470. In an embodiment, the method of patterning the dielectric material layer 440 is, for example, through the steps shown in FIG. 5C to 5E. First, as shown in FIG. 5C, a photoresist film 460 is adhered to the dielectric material layer 440. After that, as shown in FIG. 5D, a lithography process is performed to the photoresist film 460 to form a patterned photoresist film 460a. Next, an etching process is performed to the dielectric material layer 440 by using the patterned photoresist film 460a as the etching mask to form a plurality of dielectric spacers 470 as shown in FIG. 5E. Note that since the thickness of the dielectric material layer 440 corresponds to the thickness of the conventional spacers 170, the dielectric spacers 470 formed by the photolithography process have the effect as spacers.

In the present invention, the dielectric spacers 470 are formed by using the dielectric material layer 440. Compared to the conventional planar light source 100, where both the dielectric layer 140 and the spacers 170 are disposed, the process of the present invention is simpler. And the dielectric spacers 470 are fabricated through a film deposition process combined with a photolithography process; therefore, uneven thickness of the pattern film incurred by printing shift in the conventional technology, which may further result in different light-emitting performance at different areas, may be avoided.

Next, a second substrate 480 is provided, wherein the space between the first substrate 410 and the second substrate 480 is divided into a plurality of discharge spaces 500 by the dielectric spacers 470, as shown in FIG. 5F. In an embodiment, a phosphor layer 490a is further formed on the surface of the second substrate 480; the phosphor layer 490a is, for example, fully covering the second substrate 480 as shown in FIG. 5F, or is formed correspondingly in the discharge spaces 500, as shown in FIG. 4. Moreover, a dielectric layer (not shown) may be further formed on the second substrate 480, which may be bound with the dielectric spacers 470 correspondingly to form the structure of the dielectric spacers 340 as shown in FIG. 4. Accordingly, the binding precision of the first substrate 410 and the second substrate 480 can be enhanced.

After that, a phosphor layer 490b is formed in the discharge spaces 500, as shown in FIG. 5F. In an embodiment, the method of forming the phosphor layer 490b in the discharge spaces 500 includes a coating process.

Next, the first substrate 410 and the second substrate 480 are bound together, and meanwhile, the discharge spaces 500 are filled with the discharge gas 510, wherein the dielectric spacers 470 are connected between the first substrate 410 and the second substrate 480, as shown in FIG. 5G. Accordingly, the discharge spaces 500 between the first substrate 410 and the second substrate 480 can be maintained by the dielectric spacers 470.

In overview, the planar light source and the fabricating method thereof in the present invention have at least the following advantages:

(1) The space occupied by the conventional spacers can be reduced by replacing the conventional spacers with dielectric spacers. Accordingly, the discharge spaces can be increased, and further the coating area of the phosphor layer in the discharge spaces can be increased.

(2) Cracks in the substrate can be prevented since frit glue is not used in the present invention.

(3) Since the dielectric spacers are fabricated through a film deposition process combined with a photolithography process, compared to the conventional process, where the dielectric layer is fabricated and a plurality of spacers are disposed through multiple printing process, the fabricating process for the planar light source in the present invention is simpler. Accordingly, the yield of the planar light source is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A planar light source, comprising:
A first substrate;
A plurality of electrode modules disposed on the first substrate;
A second substrate disposed above the first substrate;
A plurality of dielectric spacers covering the electrode modules and connected between the first substrate and the second substrate, and the space between the first substrate and the second substrate is divided into a plurality of discharge spaces by the dielectric spacers;
A first phosphor layer disposed in the discharge spaces; and
A discharge gas disposed in the discharge spaces.

2. The planar light source as claimed in claim 1, wherein the width of the part of each dielectric spacer in contact with the first substrate is greater than the width of the part in contact with the second substrate.

3. The planar light source as claimed in claim 2, wherein the cross section of each dielectric spacer includes a trapezoid.

4. The planar light source as claimed in claim 1, wherein the thicknesses of the dielectric spacers are between about 100 μm and 5,000 μm.

5. The planar light source as claimed in claim 1, further comprising a second phosphor layer covering the surface of the second substrate.

6. The planar light source as claimed in claim 1, wherein each dielectric spacer includes a top section and a body section.

7. The planar light source as claimed in claim 6, further comprising a third phosphor layer disposed on the second substrate, and located between the top sections and in the discharge spaces.

8. The planar light source as claimed in claim 1, further comprising a reflective layer disposed between the first substrate and the electrode modules.

9. The planar light source as claimed in claim 1, wherein the material of the electrode modules is selected from the group including silver, copper, and combinations thereof.

10. The planar light source as claimed in claim 1, wherein the discharge gas is selected from the group including xenon gas, neon gas, argon gas, and combinations thereof.

11. A fabricating method for a planar light source, comprising:
Providing a first substrate whereon a plurality of electrode modules have been formed;
Forming a dielectric material layer covering the electrode modules and having a thickness on the first substrate;
Patterning the dielectric material layer to form a plurality of dielectric spacers;
Providing a second substrate, wherein the dielectric spacers divide the space between the first substrate and the second substrate into a plurality of discharge spaces;
Forming a first phosphor layer in the discharge spaces; and
Binding the first substrate and the second substrate, and filling the discharge spaces with a discharge gas, wherein the dielectric spacers are connected between the first substrate and the second substrate.

12. The fabricating method as claimed in claim 11, wherein the method of forming the dielectric material layer on the first substrate includes a coating process.

13. The fabricating method as claimed in claim 11, further comprising performing a sinter process to the dielectric material layer after the dielectric material layer has been formed on the first substrate.

14. The fabricating method as claimed in claim 11, wherein the thickness of the dielectric material layer is between about 100 μm and 5,000 μm.

15. The fabricating method as claimed in claim 11, wherein the method of patterning the dielectric material layer includes:
Adhering a photoresist film to the dielectric material layer;
Performing a lithography process to the photoresist film to form a patterned photoresist film; and
Performing an etching process to the dielectric material layer using the patterned photoresist film as an etching mask to form the dielectric spacers.

16. The fabricating method as claimed in claim 11, wherein the method of forming the first phosphor layer in the discharge spaces includes a coating process.

17. The fabricating method as claimed in claim 11, further comprising forming a second phosphor layer on the surface of the second substrate.

18. The fabricating method as claimed in claim 11, further comprising forming a reflective layer on the first substrate before the electrode modules are formed.
